(19) United States
(12) Patent Application Publication
(10) Pub. No.: US 2021/0002951 A1
(43) Pub. Date: Jan. 7, 2021

(54) FOLDING SHUTTER

(71) Applicant: Ramboll Denmark Contracting ApS, Copenhagen S (DK)

(72) Inventors: Jakob Blauenfeldt-Dydensborg, Dragor (DK); Jørn Krab Jensen, København K (DK)

(21) Appl. No.: 16/982,783

(22) PCT Filed: Mar. 18, 2019
(86) PCT No.: PCT/EP2019/056690

§ 371 Date: Sep. 21, 2020

(30) Foreign Application Priority Data
Mar. 19, 2018 (DK) PA 2018 70174

(51) Int. Cl. E06B 9/06; E05D 15/26

(52) U.S. Cl. CPC E06B 9/0669; E05D 15/266; E05D 15/262; E06B 9/0638

(57) ABSTRACT

A folding shutter having a frame with at least one linear guide rail and a carriage mounted to the linear guide rail so that it can be moved in the first direction extending between a first and a second end of the guide rail, and at least two folding shutter elements where one folding shutter element is attached to the carriage via a first and a second bracket part attached to the carriage, so that the first and the second shutter element folds when the carriage moves away from the first end of the guide rail, and wherein each of a first and a second peg is arranged on one bracket part, and extending into engagement with a first and a second slot respectively arranged on the other bracket part.

### THE PRIOR ART

The present invention relates to a folding shutters comprising a frame structure with a guide rail and a carriage mounted to the guide rail so that it can be moved between a first and a second end of the guide rail, and where the folding shutter further comprises a first and a second shutter element each having a proximal side and a distal side arranged opposite to the proximal side, and where the proximal side of the first shutter is rotatably attached to the supporting structure near the second end of the guide rail and where the distal side of the first shutter element is attached to the distal side of the second shutter element via one or more hinges having a hinge axis substantially perpendicular to the first direction, and where the proximal side of the second shutter is attached to the carriage via a bracket comprising a first bracket part being fixedly attached to the second shutter element, and a second bracket part being attached to the first bracket part and to the carriage, so that the first and the second shutter element folds in a concertina like manner, and the distal side of the first and the second shutter moves away from the guide rail when the carriage moves away from the first position along the guide rail.

Folding shutters of this kind are known in various different embodiments where especially the mechanism for opening the shutter elements are adapted for ensuring easy opening of the folding shutter, and at the same enabling secure locking of the shutter elements in the closed position.

An example of such a folding shutter is known from e.g. EP patent no. 2 540 929 disclosing a folding shutter as mentioned above.

### THE OBJECT OF THE INVENTION

On this background it is the purpose of the present invention to disclose a folding shutter of the kind mentioned in the introduction and providing an even simpler and more reliable mechanism for operating the folding shutter.

This is obtained by a folding shutter as mentioned in the introduction, and where the folding shutter further comprises a first and a second peg being arranged on one bracket part, and extending into engagement with a first and a second slot respectively arranged on the other bracket part, and where the first slot extends in the first direction when the carriage is positioned at the first end of the guide rail, and the second slot is U-shaped having two diverging slot leg portions being connected via a bended slot portion, and where the U-shaped slot is positioned so that the second peg is positioned in the U-shaped slot at the end of a first slot leg portion when the carriage is at its first position, and moves from the end of the first slot leg portion via the bended slot portion and to the second slot leg portion when the carriage is moved to the second end of the guide rail.

In this way both the initial and the following folding of the shutter elements are obtained using only a very simple mechanism and with only a few separate movable components.

In a preferred embodiment the first slot extends as an extension of the first slot leg portion of the U-shaped slot, and thereby providing an especially simple and compact bracket mechanism.

Further it is advantageous if the first slot extends at angle with respect to the second slot leg portion of the U-shaped slot, being smaller than the corresponding angle between the first slot leg portion and the second slot leg portion, so that the first and the second peg provides an initial folding of the shutter elements when the second bracket part moves from its first position at the guide rail.

In a preferred embodiment the first and the second slot are arranged at one bracket part, and the first and the second peg are both arranged at the other bracket part.

The guide rail may also comprise a driving mechanism adapted for moving the carriage between the first and the second end of the guide rail.

In a preferred embodiment the folding shutter further comprises a locking bracket with a first locking bracket fixedly attached to the second shutter element and a second locking bracket part being attached to the driving mechanism so that it moves simultaneously with the carriage along the guide rail, and the locking peg being arranged on one of the locking bracket parts and in engagement with a locking slot arranged on the other of the locking bracket parts, when the carriage is in its first position, and the locking slot being adapted such that when the carriage is moved from it first position, then the locking peg slides in the locking slut so that the two locking bracket parts are forced away from each other, and thereby further urging the first and the second shutter element to initiate folding.

In this relation the locking slot may preferably be open ended at one end, and adapted so that the locking peg is released from the locking slot, before, or simultaneously with the first peg moving along the bended portion and the second slot leg portion of the U-shaped slot.

In an embodiment the second locking bracket part forms part of the second bracket part.

Furthermore the first locking bracket part may preferably be attached to the first shutter element at a position closer to its distal side than the first bracket part.

In a further preferred embodiment the supporting structure comprises a square or rectangular frame surrounding an opening, and wherein the first and the second shutter elements are square or rectangular and covers the opening and resting against the frame in the closed position where the shutter elements are arranged virtually in the same plane.

### THE DRAWING

In the following one or more embodiments of the invention will be described in more detail and with reference to the drawing, where:

FIGS. 1 and 2: Are principle sketches showing two different embodiments of a folding shutter according to the invention.

FIGS. 2, 3, 4 and 5: Are a series of principle sketches showing different positions of an embodiment of a bracket for a folding shutter according to the invention in four different positions.

### DESCRIPTION OF EXEMPLARY EMBODIMENTS

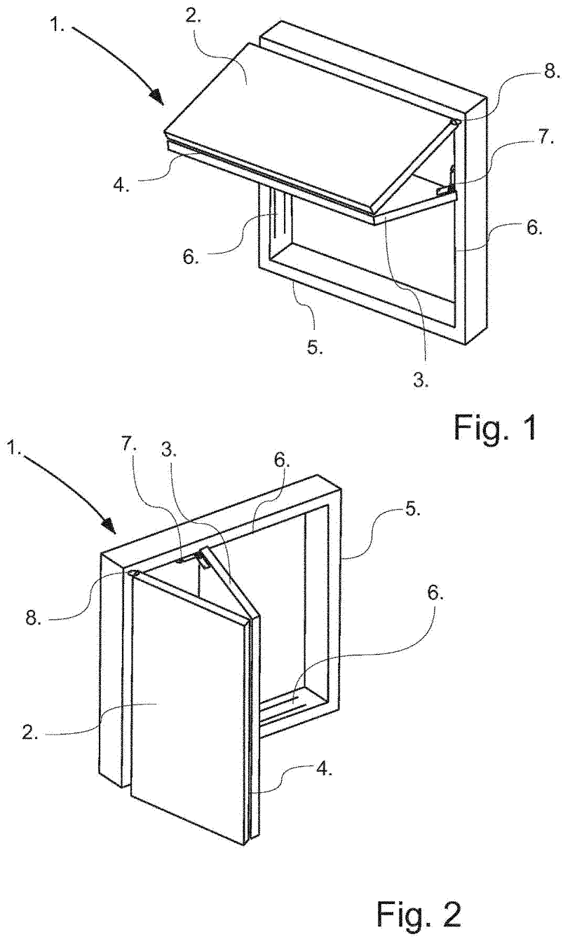

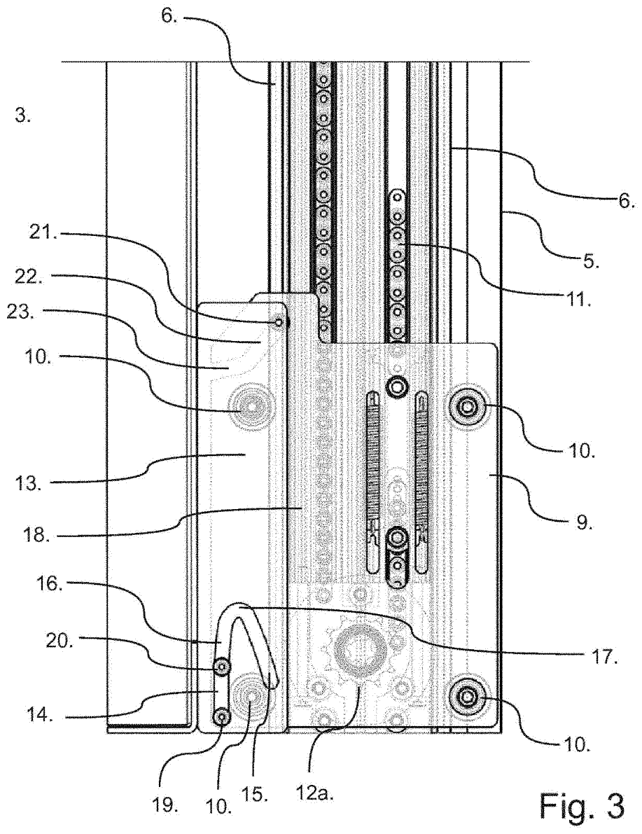

FIGS. 1 and 2 shows folding shutters 1 according to the invention, one having its folding elements 2, 3 folding vertically and the other folding horizontally. The vertical and the horizontal embodiments are practically identical and in the following we will therefore only refer to the embodiment in FIG. 1 where the folding elements 2, 3 are folding horizontally. This folding shutter has two folding shutter elements 2, 3 being mutually interconnected via a hinge 4 at their distal sides away from the supporting frame 5 in the open position of the shutter elements 2, 3 as shown on these figures.

The first upper shutter element 2 on FIG. 1 is rotatably attached via hinges 8 to the supporting frame 5 having its proximal side closest to the supporting frame 5, and the opposite distal side away from the supporting frame is attached to the corresponding distal side of the second lower shutter element 3 via a hinge 4. Furthermore the proximal side opposite to the distal side of the second folding shutter is attached to the frame 5 via a hinge bracket 7 attached to the supporting frame 5 via guide rails 6 arranged at opposite sides of the supporting frame 5.

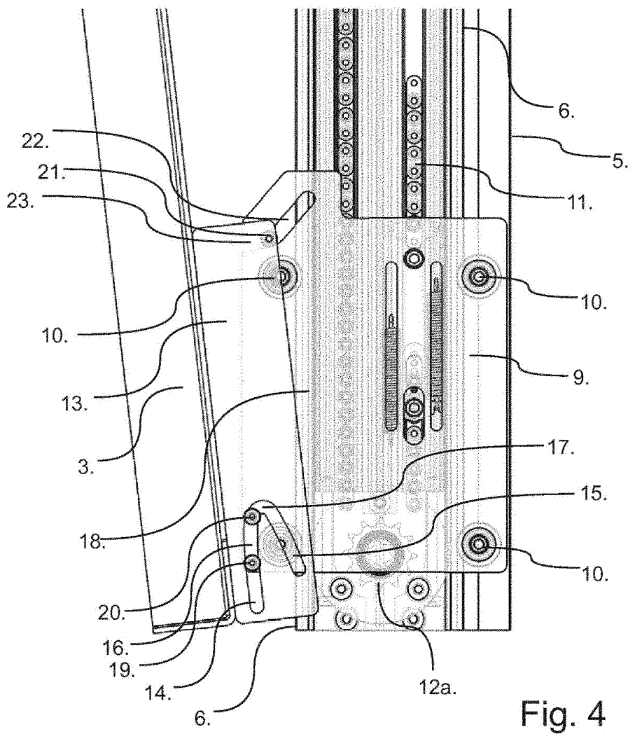

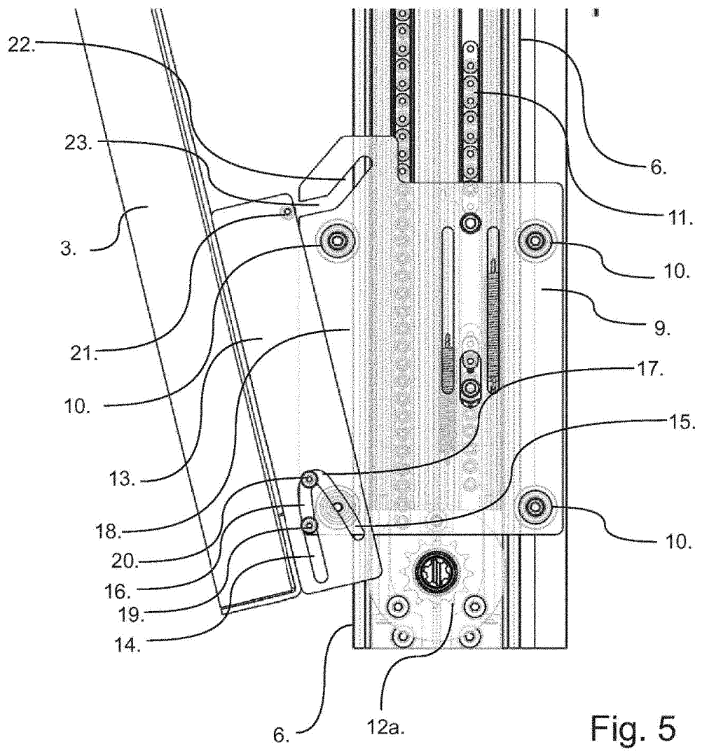

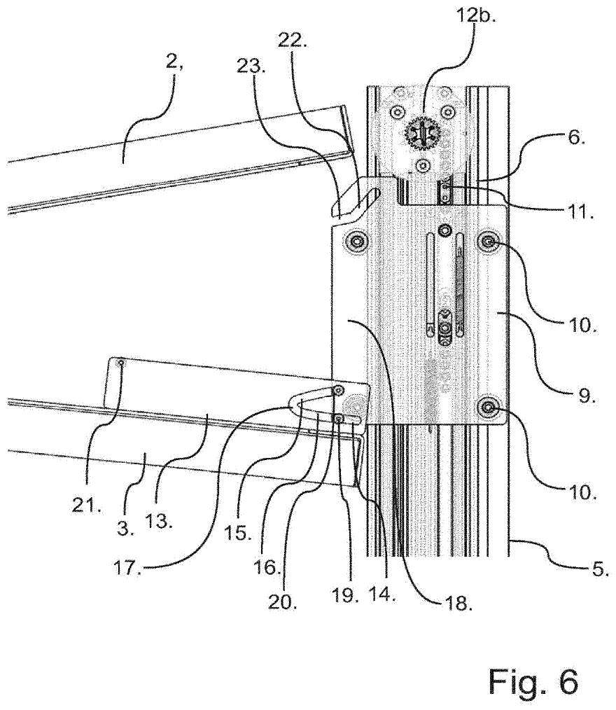

FIGS. 1 and 2 both shows the folding shutter 1 in its fully open position, but in the following the function and construction of the hinge bracket 7 according to one and the same embodiment of the invention is disclosed in more detail in four different positions with reference to FIG. 3 through 6, where FIG. 3 shows the details of the hinge bracket 7 when the folding shutter 1 is in the fully closed position of the folding shutter 1, and FIG. 6 shows the details of the same hinge bracket 7 in the fully open position of the folding shutter 1 whereas FIGS. 4 and 5 shows the hinge bracket in two different intermediate positions.

In this embodiment of the invention the frame or supporting structure 5 has two linear guide rails 6 each with a carriage 9 slidably attached to it via a set of bearing wheels 10. The carriage 9 is furthermore attached to a chain 11 extending between a set of chain wheels 12a, 12b arranged so that the carriage 9 can be urged to slide on the guide rails by rotating one or both of the chain wheels 12a, 12b. It is, however, apparent that other types of actuators than the above mentioned chain drive may be just as useful for the same purpose, such as a screw spindle or a wire or belt drive.

A first bracket 13 is attached to the second shutter element 3 and has a first slot 14 extending substantially parallel with the guide rail 6 when the carriage is arranged at its first or lowermost position nearest to the chain wheels 12a such as it is shown on FIG. 3, showing the folding shutter in its closed position where the first and the second shutter 2, 3 are extending parallel with the supporting frame 5 and in each other extension. The first bracket 13 also has a second slot formed as a U-shaped slot with two diverging leg portions 15, 16 and a bended slot portion 17 extending between the diverging leg portions 15, 16 of the U-shaped slot.

In this embodiment the first and the second slot 14, 15, 16, 17 are arranged such that the first slot extends as a prolongation of, and partly overlapping one of the legs 16 of the second slot, but it will be apparent to the skilled person that the first and the second slots may be arranged as separate slots without departing from the idea of the invention.

A second bracket 18 is integrally formed with the slidable carriage 9, and has two pegs 19, 20 where one peg 19 extends into engagement with the first slot 14, and the other extends into engagement with the second slot 15, 16, 17.

In the first lowermost position of the carriage 9 the pegs 19, 20 on the second bracket are positioned such that the lowermost peg 19 is positioned at the lowermost end of the first slot 14 and the upper peg 20 is arranged at the lowermost end of one of the diverging leg portions 16 of the second slot, and the two pegs are together keeping the second shutter element 3 in a position substantially parallel with the frame structure 5 and the guide rail 6. As the first slot 14 in this position extends parallel with the guide rail, then the lowermost peg 19 will just slide upwardly in the first slot 14 when the carriage is urged to move upwardly from its first and lowermost position near the first end of the guide rail 6. In this situation the upper peg 20 simultaneously slides upwardly in the leg 20 of the second slot that partially overlaps with the first slot 14. As this leg 20 of the second slot extends upwardly and slightly against the frames structure 5, then the upper peg urges the upper part of the second shutter element 3 to rotate away from the frame structure 5 and the folding shutter starts to move via the positions shown on FIGS. 4 and 5 and into the second position of the carriage 9 as shown on FIGS. 1, 2 and 6, where the carriage is at its uppermost position.

In this embodiment the two pegs 19, 20 on the second bracket are arranged relatively close to each other in order to provide a compact bracket structure, therefore. This, however, puts a lot of strain on the two pegs 19, 20 when the folding shutter is moved from the position as shown on FIG. 3 and to the positions shown on FIGS. 4 and 5. Therefore, in order to reduce the strain on the two pegs 19, 20 a locking peg 21 is arranged on the first bracket part at a distance relatively far away from the first and two pegs 19 and 20, and so that it slides in a corresponding locking slot 22, 23 arranged on the second bracket part and extending so that it also urges the upper part of the second shutter element 3 to move away from the frame structure 5 when the second bracket part 9 is moved upwardly from the first end of the guide rails 6.

FIG. 4 now shows position of the folding shutter 1, where the carriage 9 is urged to move a small distance upwardly from its lowermost position at the first end of the guide rail 6 where the lowermost peg 19 is moved upwardly in the substantially straight part of the first slot 14, then due to the shape of the slot leg 20 on the U-shaped slot and the first slot 14, as well as the uppermost portion 22 of the locking slot then the upper peg 18 is moved into the bended portion 17 of the second slot, and the folding shutter starts to open.

FIG. 5 now shows the next position of the folding shutter where the carriage 9 is urged to move further upwardly along the guide rail 6 from the position shown on FIG. 4. Here the lowermost peg 19 is almost keeping its position at the uppermost part of the first slot 14, but the upper peg 20 slides from one of the diverging leg portions 20 of the second U-shaped slot and via the bended portion 17 and into the other diverging leg 15 of the second slot. At the same time the locking peg 21 slides from the uppermost part 22 of the locking slot and out of the locking slot via the lowermost part 23 of it, having an angle with respect to the upper most part 22.

In this position the folding shutter further opens and the upper peg 20 and the lower peg 19 are now positioned in opposite ones of the diverging legs of the U-shaped slot.

FIG. 6 shows the folding shutter 1 at a position corresponding to the position shown at FIGS. 1 and 2 and where the carriage is moved to its uppermost position closest to the second end of the guide rail 6.

In view of the description of the embodiment of the invention described above it will be apparent to the skilled person that the principle of the invention may be conducted in various different embodiments. As an example it is possible to have the pegs 19, 20 mounted on the first bracket part 13 and the first slot 14 and the U-shaped slot 15, 16, 17 arranged on the second bracket part 18.

It is even possible to have only one peg 18 arranged on one of the bracket parts and the other peg 20 arranged on the other bracket part, and the corresponding first and second (U-shaped) slots arranged respectively on the opposite bracket parts.

Furthermore the folding shutter may or may not have identical bracket arranged at each side of the shutter elements as only one bracket arranged at one side is sufficient for obtaining complete control of the shutter elements.

Unless otherwise specified, the following terms as used herein have the meanings provided below:

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

Directional orientations such as “above”, “below”, “top”, “bottom”, and the like are made with reference to the embodiment shown I FIG. 1, where the guide rail 6 forms a vertical direction. In other embodiments, such as the one shown in FIG. 2, however, the extension of the guide rail 6 also is also defined as being vertical and the terms “above”, “below”, “top”, “bottom”, and the like are relative to this axis.

The term “substantially” is used herein with respect to measurable values and ranges due to expected variations known to those skilled in the art (e.g., limitations and variabilities in measurements).

1. A folding shutter comprising a frame or supporting structure with at least one linear guide rail extending in a first direction, and where a carriage is mounted to the linear guide rail so that it can be moved in the first direction extending between a first and a second end of the guide rail, and where the folding shutter further comprises a first and a second shutter element each having a proximal side and a distal side arranged opposite to the proximal side, and where the proximal side of the first shutter is rotatably attached to the supporting structure near the second end of the guide rail and where the distal side of the first shutter element is attached to the distal side of the second shutter element via one or more hinges having a hinge axis substantially perpendicular to the first direction, and where the proximal side of the second shutter is attached to the carriage via a bracket comprising a first bracket part being fixedly attached to the second shutter element, and a second bracket part being attached to the first bracket part and to the carriage, so that the first and the second shutter element folds in a concertina like manner, and the distal side of the first and the second shutter moves away from the guide rail when the carriage moves away from the first end along the guide rail, and wherein each of a first and a second peg is arranged on one of the bracket parts, and extending into engagement with a first and a second slot respectively arranged on the other bracket part, and where the first slot extends in the first direction when the carriage is positioned at the first end of the guide rail, and the second slot is U-shaped having two diverging slot leg portions being connected via a bended slot portion, and where the U-shaped slot is configured so that the second peg is positioned in the U-shaped slot at the end of a first slot leg portion when the carriage is at the first end of the guide rail, and moves from the end of the first slot leg portion via the bended slot portion and to the second slot leg portion when the carriage is moved to the second end of the guide rail.

2. A folding shutter according to claim 1, wherein the first slot extends as an extension of the first slot leg portion of the U-shaped slot.

3. A folding shutter according to claim 2, wherein the first slot extends at angle with respect to the second slot leg portion of the U-shaped slot, being smaller than the corresponding angle between the first slot leg portion and the second slot leg portion.

4. A folding shutter according to claim 1, wherein the first and the second slot are arranged at one bracket part, and the first and the second peg are both arranged at the other bracket part.

5. A folding shutter according to claim 1, wherein the guide rail comprises a driving mechanism adapted for moving the carriage between the first and the second end of the guide rail.

6. A folding shutter according to claim 5, and further comprising a locking bracket with a first locking bracket fixedly attached to the second shutter element and a second locking bracket part being attached to the driving mechanism so that it moves simultaneously with the carriage along the guide rail, and where a locking peg is arranged on one of the locking bracket parts and in engagement with a locking slot arranged on the other of the locking bracket parts, when the carriage is in its first position, and where the locking slot is adapted such that when the carriage is moved from it first position, then the locking peg slides in the locking slut so that the two locking bracket parts are forced away from each other, and thereby urging the first and the second shutter element to initiate folding.

7. A folding shutter according to claim 6, wherein the locking slot is open ended at one end, so that the locking peg is released from the locking slot when the first peg moves along the bended portion and before it enters the second slot leg portion of the U-shaped slot.

8. A folding shutter according to claim 7, wherein the second locking bracket part forms part of the second bracket part.

9. A folding shutter according to claim 8, wherein the first locking bracket part is attached to the first shutter element at a position closer to its distal side than the first bracket part.

10. A folding shutter according to claim 1 wherein the supporting structure comprises a square or rectangular frame surrounding an opening, and wherein the first and the second shutter elements are square or rectangular and covers the opening and resting against the frame in the closed position where the shutter elements are arranged virtually in the same plane.
